(19) United States
(12) Patent Application Publication
(10) Pub. No.: US 2018/0357150 A1
(43) Pub. Date: Dec. 13, 2018

(54) SYSTEM FOR DEVELOPMENT AND EMULATION OF EMBEDDED SYSTEMS

(71) Applicant: Embeddetech, Inc., Tulsa, OK (US)

(72) Inventors: Ashok Kumar Chaubey, Mahavir Enclave (IN); DEVENDER NATH MAURYA, Madanpur Khadar (IN); Devender Pal Sharma, Uttar Pradesh (IN); Jonathan Torkelson, Tulsa, OK (US); Manish Dubey, Kanpur (IN); NICHOLAS WESLEY VINYARD, Plano, TX (US)

(21) Appl. No.: 16/002,883

(22) Filed: Jun. 7, 2018

Related U.S. Application Data
(60) Provisional application No. 62/516,303, filed on Jun. 7, 2017.

(51) Int. Cl. G06F 11/36

(52) U.S. Cl. CPC G06F 11/3664

(57) ABSTRACT

A computer based electronic device emulation and development system includes examining a target platform program and determining a first memory location utilized by the target platform program, and providing a first software object to a host program containing a function that allows access to the first memory location.

### CROSS-REFERENCE TO RELATED CASES

This application claims the benefit of U.S. provisional patent application Ser. No. 62/516,303, filed on Jun. 7, 2017, and incorporates such provisional application by reference into this disclosure as if fully set out at this point.

### FIELD OF THE INVENTION

This disclosure relates to embedded systems in general and, more particularly, to design and testing of embedded systems.

### BACKGROUND OF THE INVENTION

General purpose computers may be equipped to work toward a number of tasks and can be equipped with a number of general purpose peripherals (e.g., keyboard, mouse, video monitor) that are also useful in a multitude of endeavors. Open expansion ports of various kinds are generally provided to allow connection of additional hardware and peripherals that may not have even been considered when the general purpose computer system was built. Introduction of new software to the general purpose computer system allows interaction with the new peripherals and expansion of the basic abilities of the general purpose computer system itself. Even the operating system may be upgraded over time to enhance the abilities of a general purpose system.

Somewhat in contrast to a general purpose system is the concept of an embedded system. An embedded system may be configured to work for its entire service life with a specific set of peripherals that may be intended to accomplish a limited number of tasks. One example would be the on-board processing necessary to operate a hand-help global positioning system (GPS) unit. The user input and output options such as buttons and/or a touch screen are typically fixed at the time of manufacture and peripheral expansion options can be severely limited. Moreover, even if software updates are provided, these are generally to refine or improve the ability of the embedded system to accomplish its originally intended task rather than add heretofore uncontemplated functionality.

Unlike a general purpose computing system, the components of an embedded system are typically chosen to fulfill a specified task as inexpensively and as efficiently as possible. For example, the microcontroller embedded in a residential digital thermostat need never do anything more complicated than measure temperature and turn an HVAC unit on or off. A full powered x86 compatible processor would be excessive for such an application (e.g., expensive and power hungry). Therefore, low cost, low power silicon is typically employed.

Microprocessors in embedded systems often do not have complex operating systems nor large libraries of device drivers and controllers that may be necessary or useful in interacting with the wide varieties of sensors, probes, actuators, and I/O devices that may be utilized in the embedded system. This means design time systems may need to be specified, programmed, and physically prototyped before real testing can begin. Only after extensive physical prototyping and testing have occurred can the work begin of physically optimizing the product into a suitably attractive and durable consumer or industrial product and what is hopefully a competitive price.

Although manually coding the embedded system to accomplish its intended task may be something that can never be entirely avoided, the need to physically build and test prototypes is a leading driver of the expense of developing an embedded system.

What is needed is a system and method for addressing the above, and related, issues.

### SUMMARY OF THE INVENTION

The invention of the present disclosure, in one aspect thereof, comprises a computer based electronic device emulation and development system including a processor that executes instructions and a random access electronic memory that stores data and instructions for execution by the processor. The processor instructions include examining a target platform program and determining a first memory location utilized by the target platform program, and providing a first software object to a host program containing a function that allows access to the first memory location.

The first software object may provide a function that allows the first memory location to be read by a host program while the target platform program is executing. It may also provide a function that allows the first memory location to be written to by the host program while the target platform program is executing. The first software object contains a variable that is bound to the first memory location.

The computer based electronic device emulation and development system may include processor instructions for providing a second software object to the host, the second software object providing for the host a function to start execution of the target platform program, and a function to stop execution of the target platform program. The system may also include instructions for examining the target platform program and determining a data stream utilized by the target platform program, and instructions for providing a function that allows access to the data stream with the first software object provided to the host program. Data stream access may be read or write access and be provided for any data interface that streams data including, without limitation, analog to digital converters, TCP sockets, and audio codec channels.

The computer based electronic device emulation and development system may also include a display and processor instructions for indicating on the display contents of the first memory location retrieved by the host program using the first software object.

The invention of the present disclosure, in another aspect thereof, comprises a computer based electronic device emulation and development system including a processor that executes instructions, a random access electronic memory that stores data and instructions for execution by the processor; an input device accepting input from a user, and an output device for displaying information to the user. The system includes processor instructions for accepting from a user a designation of a target control program for an associated embedded system. Instructions include examining the target program to determine a designation for a memory location accessed by the target control program during execution that corresponds to an input or output of the associated embedded system and providing to a host program a software object allowing access to the memory location.

Instructions may also be included for providing a software object allowing the host program to begin and end execution of the target control program any number of times during hosting of the target control program. Instructions may also include instructions for displaying in the host program a visual indication of the input or output of the embedded system based upon contents of the memory location accessed by the host program. The instructions may include instructions for accepting input into the host program and passing the input to the memory location using the provided software object. The memory location may also be a non-volatile memory storage. The input may be user provided.

The invention of the present disclosure, in another aspect thereof, comprises a method of computer based electronic device emulation and development including receiving a target platform control program and examining the target platform to determine a designated memory location corresponding to an input or output of the control program. The method includes compiling the target platform control program with a hardware abstraction layer directing the input or output to a designated memory location and binding the designated memory location to a software object of a host program to allow the host program to access the designated memory location. The method includes executing the host program and the target platform control program on the same computer and synchronizing memory reads and writes of the designated memory location between the target platform control program and the host program. Proxied memory locations existing on physically remote machines may be synchronized and utilized as well.

In some embodiments, the method includes displaying on a computer display a visual indication of the designated memory location. The method may include accepting user input into the host program for passing to target platform control program via writing to the designated memory location. The target platform control program may be recompiled with a hardware abstraction layer corresponding to an associated physical platform.

The method may include providing a second software object to the host program that allows the host program to control execution of the target platform control program. The method may also include selecting one or more parameters corresponding to the designated memory location and displaying the selected one or more parameter to a user via the host program.

### BRIEF DESCRIPTION OF THE DRAWINGS

FIG. 1 is a flow chart depicting a program development cycle according to aspects of the present disclosure.

FIG. 2 is a simplified block diagram of an example physical target device.

FIG. 3 is a logical diagram depicting example control software for the physical target device of FIG. 2.

FIG. 4A is a software structure chart for a control program compiled with physical drivers according to aspects of the present disclosure.

FIG. 4B is a software structure chart for a control program compiled with virtual drivers according to aspects of the present disclosure.

FIG. 5 is a software structure chart for a system for development and emulation of an embedded system according to aspects of the present disclosure.

FIG. 6 is another software structure chart for a system for development and emulation of an embedded system according to aspects of the present disclosure.

FIG. 7 is a software structure chart for a system for development and emulation of an embedded system according to aspects of the present disclosure configured to incorporate access to a data stream.

FIG. 8 is a perspective view of a system for development and emulation of an embedded system according to aspects of the present disclosure.

FIG. 9 is a flow chart illustrating a design flow according to aspects of the present disclosure.

FIG. 10 is a graphical representation of connections between virtual input/poutput ports of a control program and target firmware.

FIG. 11 is a graphical representation of a simulated hardware device running on a host environment.

### DETAILED DESCRIPTION OF THE PREFERRED EMBODIMENTS

In conventional embedded systems design, workflow begins with a need to develop custom electronic hardware for a specific application. A functional product specification may be provided (e.g., by a marketing team) to establish product-level requirements. These may be translated to technical design requirements and implemented by an engineering team.

The design requirements may involve development of custom PCB (Printed Circuit Board) hardware comprising a generic, commercially available microcontroller as well as other components needed to support the application (touch screens, keypads, analog circuitry, communication busses, etc.). As a step toward design of the physical system, the individual electronic components are selected, and then a schematic capture of the circuit design is performed.

The PCB “footprint” of each component is then captured and the printed circuit board layout is performed for one or more boards in the product. The layout includes careful routing of all schematic traces. The bare PCB is then fabricated and “populated” with the components. Only at this point can software developers begin writing device drivers that allow the microcontroller to interface with the application-specific circuit components. The microcontroller firmware “application layer” then runs on top of the drivers.

A PCB assembly (“PCBA”) is a subassembly of a product that typically must be designed to simultaneously satisfy all relevant design requirements. The PCBA must have all of the components needed for a functional design, and must meet the cost requirements. The PCBA must meet the physical constraints of the mechanical enclosure of the production device and properly match the features of the mechanical design. The PCBA must satisfy the manufacturing reliability and electromagnetic requirements of the product. The PCB and affixed components must meet the lead time and component market life cycle requirements. The microprocessor utilized with the PCB must also have the resources (e.g., memory, program size, I/O capability, power, heat dissipation, etc.) needed for the application.

There are many opportunities for mistakes, delays, setbacks, and cost overruns. For example, a software developer typically must guess the application size and resource requirements (of the microprocessor) with very limited information. If the guess is wrong or the scope of the application increases, a different microprocessor must be selected for the hardware design. Other components of the PCBA may need to be altered as well.

The traditional tight coupling of these concerns often creates a project workflow deadlock that requires substantial engineering effort to unravel. While these requirements are of no concern to the firmware application developer, the logistics have direct and dramatic impact on the software development cycle and software developer productivity.

It should also be noted that developer productivity is extremely limited by current debugging technology. The most common embedded firmware debugging workflow uses in-circuit debugging. However, the following steps must be taken each time the developer wishes to test a change to so much as a single line of code: the embedded firmware is compiled using the microcontroller vendor-specific toolset; the microcontroller on the custom hardware target is programmed using a USB debugger hardware purchased by the microcontroller vendor; breakpoints are set for the debugger hardware to pause the on-target microprocessor when an instruction is reached (and often the number of breakpoints and other debug features are limited); stepping through code involves complex interactions between the microcontroller integrated development environment (IDE), the debug tool, and the microprocessor, resulting in significant debug cycle delays. (Whereas stepping through code in a Windows PC application is instantaneous, individual instructions executed using the in-circuit debugger may take tens of seconds to execute).

The debug process is more complicated for Field Programmable Gate Arrays (FPGAs) or embedded systems with more complex bootstrapping sequencing. The result is enormous costs and complexities associated with a firmware developer solving application coding problems. Evaluation of firmware variables is also commonly extremely limited, as each time code is executed, the variables of interest must be re-loaded over the debugger tool into the development environment. Variables involving pointers to structures in memory commonly do not provide the “indirect” information of what is pointed to, which is of most value to the developer and always available in standard native C/C++ Windows PC application development. Hardware must be available for the developer to debug. If prototypes are expensive and in limited supply, and developers must share hardware, the workflow is similarly delayed. If prototype hardware is damaged during development, new prototypes must be built, involving cost and scheduling delay.

Embedded systems are intrinsically difficult to test, for the following common reasons. The Human-Machine Interface common to embedded systems, such as pushbuttons, keypads, LEDs, touchscreen menus, etc. require manual testing by software test engineers. For example, for each production release, a test plan must include a test engineer manually navigating a menu system using keypad to ensure that the application runs as expected.

Development of “test harnesses” for an embedded system's sensor inputs and outputs can be very difficult or expensive. For example, a microcontroller may be required to monitor messages on a vehicle's CAN bus and must identify dangerous situations. Run-time reproduction of all ‘dangerous situations’ might normally involve physical recreation of the use cases for testing. An embedded process control system may monitor several stochastic process inputs. Test coverage of all operating points in the physical system in the presence of noise and stochastic variation is extremely expensive. Changes in specification that result after testing can confound the factors above as well. Oftentimes, a product works well on paper but fails in the field.

According to various embodiments of the present disclosure, an embedded virtual device framework allows application code to be cross complied, developed, run, and tested in a virtual device in parallel with the target hardware. All code may run on the local computer used by the developer. There is no program image load time, there are no debugger setup requirements, and the source code stepping is instantaneous and unrestricted. All runtime memory is directly accessible and there are no restrictions on complex breakpoints.

Embodiments of the present disclosure are built upon a general purpose computer (a virtual device “host” computer) having a processor and memory as well as typical I/O peripherals (e.g., keyboard, monitor, mouse, USB ports, etc.). The general purpose host computer may be a desktop or laptop PC, a sufficiently powerful tablet device, or a may be deployed to a website server for training or other purposes. Applications and application components developed in high-level languages on the host computer provide flexible interaction between host application functions and the user (through the computer screen, mouse and keyboard), or through commonly available off the shelf components (USB devices, cameras, data acquisition systems, etc.), or through networking functions (TCP/IP communications). The embedded virtual device framework allows embedded code executing in a virtual device on the host to integrate with these host applications and application components to facilitate rapid development, testing, and evaluation. Embodiments of the present disclosure allow developers to easily develop virtualized embedded components to interact with the virtual microcontroller or use previously developed off-the-shelf virtual components. Embodiments of the present disclosure also allow multiple virtualized embedded microcontrollers to be simulated simultaneously on the same host and interact with each other while executing their respective embedded code.

Embedded applications are most commonly written in C or C++ code. The C/C++ language establishes how data and application logic is implemented as a sequence of logical instructions and interactions with memory. A C/C++ compiler converts the C/C++ code (“embedded code”) to machine instructions specific to the target the compiler is compiling to. Thus, the source code composing a C/C++ application can, in principle, be compiled and run on any target processor, whether the target processor is an 8-bit microcontroller with 2 kiloBytes of instruction memory or a modern desktop computer. In either case, the code may be executed in sequence, exactly the same on multiple platforms.

Whether the embedded code is being executed on an embedded microcontroller or a host computer, it can only access memory and execute instructions on the memory associated with the processor on which it is executing. Most memory serves to simply store and retrieve data for use by the embedded code. Some regions of memory, called hardware registers, are accessed exactly the same as any other memory by the CPU, but are physically wired on chip to control hardware. For example, a single bit in a single memory location may control a digital output, determining whether the output is high or low. When a logical ‘1’ is written, the digital output goes high, and when a ‘0’ is written, the output goes low. When an embedded microcontroller begins executing a compiled application, its only access to the ‘outside world’ is through these hardware registers. Yet ultimately all functionality of integrating external components with a microcontroller, from wireless communications to touch screens to sensor inputs, ultimately consists of an embedded microcontroller interacting with memory. The design efforts of developing and testing an embedded application thus ultimately result in embedded source code which functions as expected to meet the requirements of the embedded system. However, the conventional process to develop and test the embedded application code, including the logistics associated with the co-development of custom hardware and the restrictions of only being able to test the code on the custom hardware, suffers enormously in terms of efficiency and effectiveness.

An embedded virtual device framework according to the present disclosure performs a number of functions. These may be considered as design-time functions, or functionality that occurs when virtual devices aren't being simulated, and run-time functions, or functionality that occurs during execution of the virtual devices.

At design time, embodiments of the present disclosure automate the creation of a host solution and a high-level language project to serve as the host application. Here virtualized hardware components can be easily developed and shared. A single host solution supports multiple projects, these being a host project itself and one or more target low-level language projects. The low-level language project may be based on C/C++ or another low-level language that is deployed with respect to an embedded controller, processor, or microprocessor. The low-level code can be developed with a microprocessor specific IDE (integrated development environment) such as Visual Studio, MPLAB, Code Composer Studio, or others. The host solution may be a high-level language project. C# is one high-level language that may be deployed as part of the host solution, but other high-level languages and platforms are contemplated. Without limitation these would include VB.NET, Windows Phone, iOS, and Android. C/C++ projects.

Systems of the present disclosure also provide a framework that automates the creation of one or more C/C++ projects which can cross-compile the same embedded code to run on the host computer. These are the virtual targets. Each virtual target virtualizes the execution of code on a microcontroller on a separate thread, and in a separate process. Multiple microcontrollers may be virtualized simultaneously to simulate multiple-microcontroller embedded systems. Each of these target threads correspond to a normal thread executing code in a microcontroller and interacting with memory in exactly the same way as physical microcontrollers. The systems of the present disclosure thus provide for parallel execution of the target code for a physical target device with the host solution's more powerful testing and debugging operations.

When the host solution is built, separate executable assemblies are built for each project: the host project and each target project. The framework of the present disclosure then analyzes the output assembly for each target that is built and parses out all functions and variables in the assembly. When the target assembly is loaded by the host computer and executed, the framework knows exactly where every function and variable is located in memory. The framework provides design-time support to expose functions and variables in the target executables to the host assembly, by generating a class object to interact with the target logically. In the physical target, a bit in a register (memory location) could control a digital output. In the virtual target, the same register could be declared, and the framework would be used to parse that register's location and expose it as a Boolean port that can be connected to other components when the virtual target runs on the host machine. Thus, this is a design time operation that allows the host application to be aware of what is going on in a completely separate target application process.

The frameworks of the present disclosure allow virtual interrupts to be configured to specify a target function to be called at a when a corresponding interrupt source has been fired. As a non-limiting example, a host timer component can be connected to a target's system clock interrupt to fire a simulated interrupt every millisecond to function the same way as a hardware timer running on an embedded system. Embodiments of various frameworks allow for data streams to be defined and routed between the host application and the target applications. Embodiments of various frameworks also allow for the target to signal events to other components. This give more complete control over the virtualized processor and its control programming to provide full testing and control over the virtual target device (as virtualized on the same physical hardware as the host programming).

When the host runs (at runtime), frameworks of the present disclosure handle launching and managing the runtime execution of each of the virtual targets, including creation and destruction of the targets on virtual power-up/power-down/reset, and including attachment of a runtime debugger to each target process. For example, as with a physical embedded target system, the device might be powered on and off, thus the virtual targets must similarly power on and off.

As configured at design time to expose variables and functions in the target to the host, the framework works at runtime to keep the host and target synchronized at runtime. In the digital output example, if the embedded code executes an instruction to write a ‘1’ to the register bit controlling the digital output, the framework provides the necessary notification to the host that the register has changed, so that some related component action can be executed. According to various embodiments, the framework allows specific variables that are compiled in a target to be marked as “Non-Persistent” or “Persistent”. A non-persistent variable is initialized to a default value each time the target is run, as is normally done when any application starts. Thus, when a target is stopped and restarted, the value in the variable is reset to a default value and is lost from the previous execution instance. A persistent variable's value is saved and stored to disk when the host is closed or the target is stopped. When the target is run, it is first loaded into memory, and then the persistent variables are initialized to their previously stored value before the target is allowed to run. The configuration of these target variables as persistent or non-persistent is a design-time configuration in the framework. Normal RAM is volatile and is lost when power is removed. The framework support of variable persistence allows the virtualization of non-volatile memory such as EEPROM and flash memory.

In addition to the design time support of identifying target variables as persistent or non-persistent, the framework must implement the mechanics of persistence at runtime. Thus, when the host solution is run, each virtual target may be powered on and off many times without the host solution closing. Each time a virtual target powers down, the framework captures and stores all persistent variables to the host computer's hard drive, and each time a virtual target powers up, the persistent variable values are loaded from the hard drive and into the target memory before execution begins.

According to some embodiments, the framework supports the runtime implementation of virtual interuptss and virtual data streams between the host and the virtual targets. The framework also provides a rich design-time support for the automated or assisted development of new components as well as automating or assisting the integration of the components to the virtual targets using the framework.

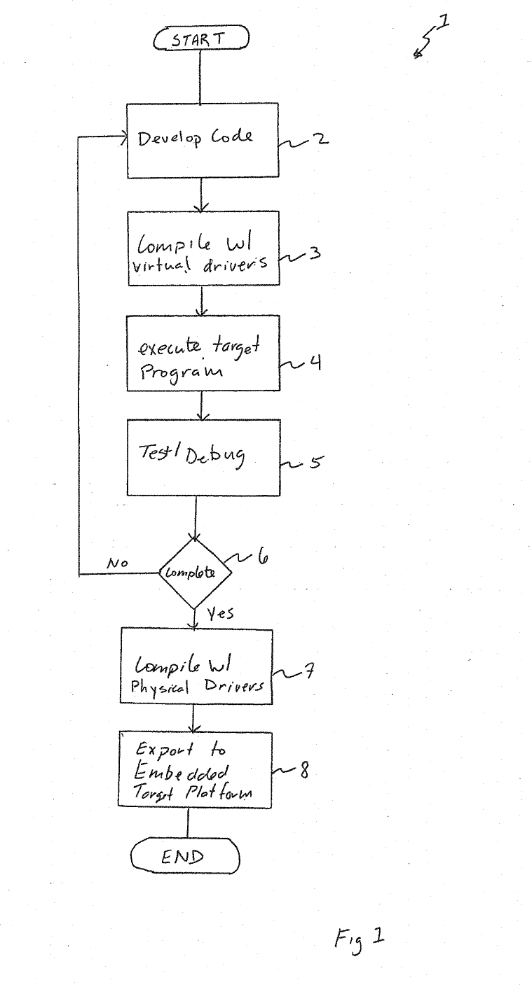

Referring now to FIG. 1 a flow chart depicting a program development cycle according to aspects of the present disclosure is shown. At step 2, code development for an embedded system takes place and is implemented by a coder, developer, or user for an embedded system. An IDE may be used, and code is developed for a physical target system such as an embedded microcontroller. For purposes of the present disclosure, code that is written during development for the target system is referred to as developer or developed code. This would be differentiable from host code or driver code. The host code would be used by the host system to test a target virtual system. Driver code would provide device-level access (to a physical or virtual device) for the developer code.

The developed code may be identically written whether using a virtual driver or a physical driver if the virtual device drivers provide the same interface (e.g., data structures, calls, functions, etc.) as the physical device drivers. For code portability, developers should follow such a practice. This also lets device driver be updated without breaking the developed code and is a principle of object-oriented programming. Compiler switches may be used, and/or header files changes, to effect compiling for a virtual device or a physical device with no change to the developed code needed.

Following code development, the code may be compiled with virtual drivers at step 3. This results in a completed set of code for a target virtual device. At step 4, the target virtual device may be loaded and started running. At step 5, the target may be tested and debugged using the host application, interface, and/or framework of the present disclosure. The host interface and framework of the present disclosure allow the target (or multiple targets) to be executed on the same physical computer in a virtualized environment. Thus, as explained herein, the virtual machine can be stopped, started, and debugged entirely within the host platform application without having yet built any physical target device or devices. If the first build of the code is unsuccessful as determined by the developer at step 6, the process may return to code development at step 2. The process of code development and testing may be iteratively repeated until the developed code (e.g., the target device) performs acceptably.

At step 7, once the developed code has performed satisfactorily, it may be compiled to operate on the physical target device. The compilation and linking procedures of step 7 differ from those of step 3 in that the code corresponding to the physical drivers and devices, rather than the virtualized drivers, is included in the final executable. Again, no change should be required to the developed code so long as the interfaces between the virtual and physical drivers is the same. The two driver versions would simply be different implementations of the same interface as facing the developed code. Finally, the completed executable may be loaded onto the target device at step 8. Now the development needed for the physical target device is complete, and the device should operate physically as it operated during virtual testing (subject, of course, to satisfactory operation of adjunct and related components that were heretofore only virtualized).

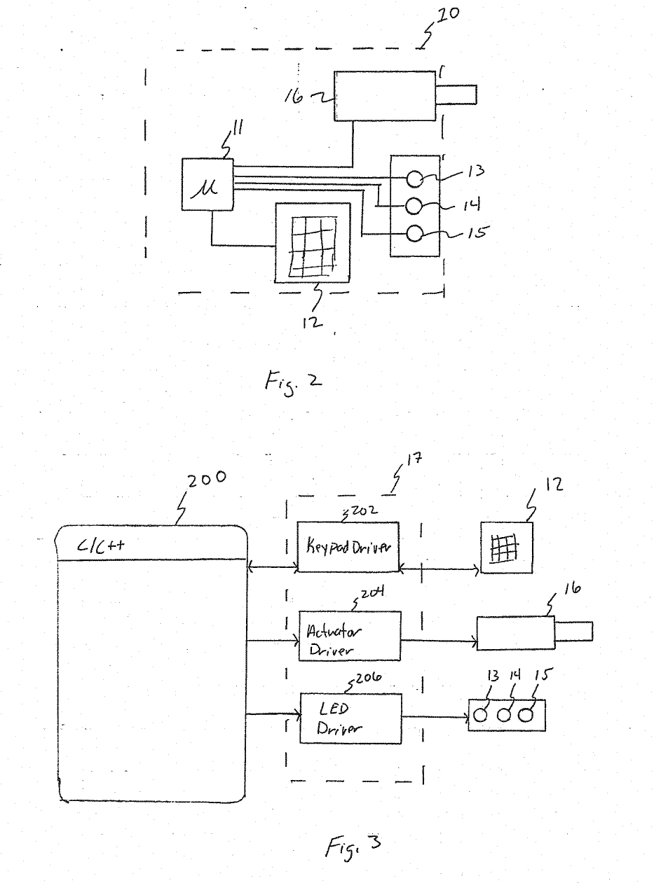

Referring now to FIG. 2, a block diagram of a simplified exemplary embedded microcontroller-based device is shown. The device 10 is an example of a physical target device that may be virtualized on a general purpose computer using systems and frameworks of the present disclosure. Access may be provided by the framework to the host program solution, which may be operating on the same general purpose computer as the virtualized target (e.g., possibly on a different thread).

The example physical target device 10 comprises an electronic combination lock. The lock 10 may be controlled by an embedded microcontroller 11 that accepts input from a user accessible keypad 12. Light emitting diodes (LEDs) may be provided for user feedback. For example, a button press may be indicated as received by an amber LED 13. A failed combination entered on the keypad 12 may be signaled by a red LED 14. A correct combination may be signaled by a green LED 15. An actuator 16 may be activated by the microcontroller 11 to physically lock or unlock the lock 10. Power supplies, external amplifiers, enclosures, and other components required to construct an actual lock are not shown for simplicity, but will be well known and understood by those of skill in the art.

The example electronic lock 10 is a very simple target device that may not require a great deal of coding skill to program, but it serves as an easily understood example of a system that could be developed and implemented virtually by systems and methods of the present disclosure before any physical product or prototype is constructed.

Referring now to FIG. 3 a logical diagram depicting example control software for the physical target device of FIG. 2 is shown. FIG. 3 illustrates diagrammatically the way the software operating on the microcontroller 11 might be arranged. Here, the software is presumed to be in executable form, rather than source code. Developer code 200 may interact with a keypad driver 202 in order to receive an entered keycode (or individual button presses). An actuator driver 204 may control the actuator 16 and an LED driver 206 may control the LEDs 13, 14, 15. The keypad driver 202, actuator driver 204 and LED driver 206 may be thought of as forming a hardware abstraction layer 17.

The developer code 200 ultimately accesses the values and functions of the drivers by referring to memory locations (which may be returned by function calls). Even if the developer code 200 cannot rely on drivers, API's, or other abstraction mechanisms, at the software level the programmer interacts with the outside world entirely by accessing memory or register locations. Thus, the developer code 200 can be developed in a virtual environment so long as the code has access to what it takes to read, and, if necessary write to, the proper memory locations (or proper function calls through drivers to access the proper memory location). Accordingly, if implemented properly, code developed for a virtual device should port to an actual embedded controller, according to aspects of the present disclosure.

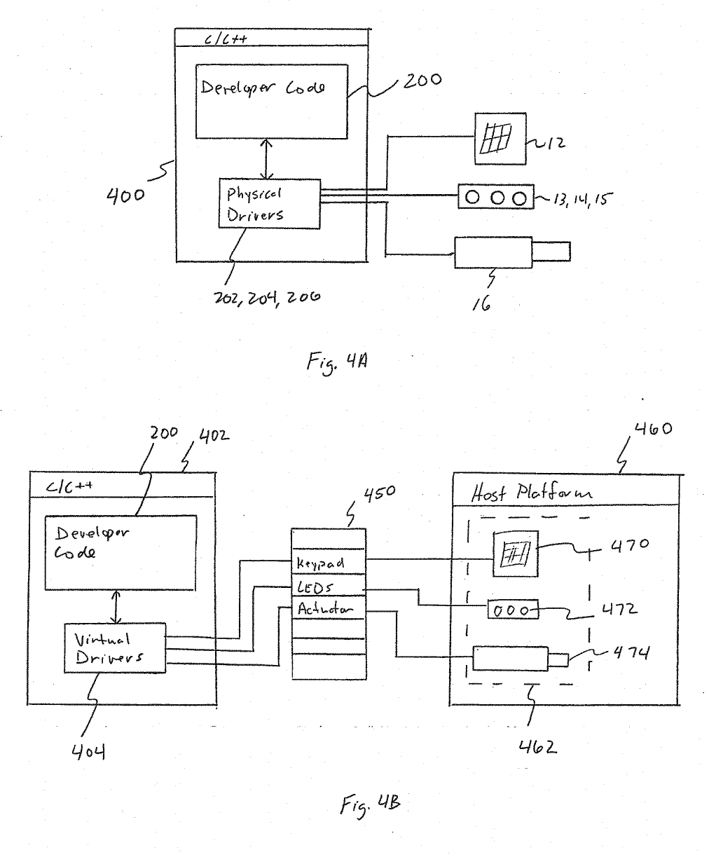

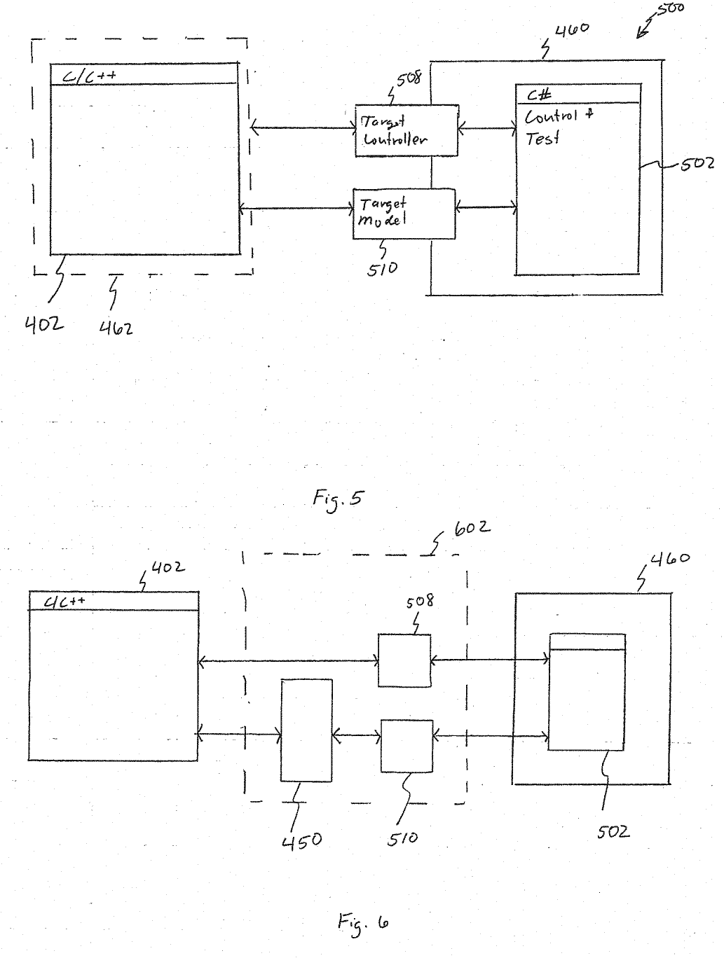

Referring now to FIG. 4A, a software structure chart for a control program 400 compiled with physical drivers according to aspects of the present disclosure is shown. FIG. 4 illustrates the concept that the completed control program or software 400 that operates an embedded system may comprise both developer code 200 and drivers 202, 204, 206. The developer code 200 may be said to occupy an application layer while the drivers may be said to comprise a hardware abstraction layer 17, (FIG. 3). Here the hardware abstraction layer 17 and drivers 202, 204, 206 would correspond to actual, physical hardware. Using the example from FIG. 2, the physical hardware would comprise the keypad 12, the LEDs 13, 14, 15 and the actuator 16. The developer code 200, insofar as its functionality is concerned, is agnostic with respect to what occurs beyond the drivers 202, 204, and 206, and thus may be operated in a virtualized target.

Referring now to FIG. 4B, a software structure chart for a control program 400 compiled with virtual drivers 402 according to aspects of the present disclosure is shown. Here, the developer code 200 may be identical to the code that would be complied if physical drivers were used. However, the control program 402 is compiled with virtual drivers 404. The virtual drivers 404 replace the functionality of the driver 202, 204, 206 that would be used for a physical target implementation. The virtual drivers 404 are used to interact with a virtualized hardware layer. In a virtualized environment, the hardware layer is represented by a memory array 450. The memory array 450 may be random access memory (RAM) or other memory accessible to a host platform 460. The host platform 460 may be a C# or other high-level development environment running on a general purpose computer. Thus, the control program 402 (including developer code 200 and drivers 404) may be executed on a processor or processor thread(s) associated with the same general purpose computer on which the host platform is running.

The memory array 450 has locations therein that are associated with logical states of the virtual drivers. The memory array 450 has a memory location 452 associated with a virtual keypad 470, a memory location 454 associated with virtual LEDs 472, and a memory location 456 associated with a virtual actuator 474. The virtual keypad 470, virtual LEDs 472, and virtual actuator 474 may be considered as virtual component corresponding to the physical keypad 12, LEDs (13, 14, 15), and actuator 16, respectively. The framework first allows the logical states of the virtual drivers to be accessible to the host, and then allows the logical states to be easily connect to their corresponding host components. This may be done, at least in part, using a graphical interface to aid efficient design and programming.

The application code 200 has no way to know that it is not accessing a physical keypad and simply uses the result returns from the virtual driver function call, which in turn accesses memory location 452, which is connected to the keypad host component 470. Similarly, so long the virtual driver allows the developer code 200 to update memory location 456 to update the logical state corresponding to the actuator 16 the developer code operates as planned. The same situation exists for the LEDs 13, 14, 15. It should be understood that the memory values may be updated or accessed by various function calls that are provided by the drivers 404, if proper abstraction rules are followed. The function calls would correspond to operation or data acquisition from physical components if physical drivers were used (e.g., as in FIG. 4A).

A host platform 460, according to the present disclosure provides access for a host program to interact with the target platform (represented here by control program 402) in a number of ways. The host program may be a debugging or testing suite written in a high-level language such as C#. The host program may be configured to interact with the target platform 402 in ways that replicate the physical operation of the target platform. Thus, a virtual representation 462 of the target platform may be provided through the host program. The virtual representation 462 may be a logical representation but may also provide for photorealistic representation of the physical target platform. In this way, the physical constrains associated with the target platform may be considered along with the program development aspects. Here, the virtual keypad 470, virtual LEDs 472, and virtual actuator 474 are shown as components of the virtualized target platform 402. Manual or automated testing functions may be implemented by the host program to fully test and debug the developer code 200 of the target platform. For example, keypresses may be provided to the running developer code 200 by use of the virtual keypad 470 on a display of the host platform (or even a real keypad attached to the host platform). The shared memory 450 accessed by the virtual drivers and exposed for access by the host components may involve data transfer from the host 460 to target 200, or from the target 200 to host 460, or bidirectional data transfer. Transfer of data to/from the host 460, logically, may be to/from a control and test program 502 discussed below.

Although the exemplary physical target platform 10 is a simple device, it should be appreciated that vastly more complex devices can be virtualized and tested according to systems and methods of the present disclosure. Functions relating to the hardware abstraction layer (here drivers) may need to be created once for the virtual target implementation and once for the physical target device implementation. It is contemplated that manufacturers of physical components that are operated by software device drivers will provide their own ports of drivers for a virtual device (e.g., the producer of the keypad 12 and its driver 202 can also provide a virtualized device driver if necessary).

Drivers and code that are specific to a virtualized platform versus a physical target platform can both be included in a single source code file for a target platform. Complier switches may be used to ensure that only the correct version is compiled. For a virtual target, a symbol can be defined as a preprocessor compiler directive which will not be defined in the physical target compilation, and compiler switches referencing this symbol can modify the complied code. Again, this allows the developer code 200 to remain agnostic as to platform (physical or virtual) so long as the interface to the physical drivers versus the virtual drivers remains the same, as it should. Those of skill in the art will readily appreciate the use of compiler switches and the like to implement such a regime.

Referring now to FIG. 5 a software structure chart for a system for development and emulation of an embedded system according to aspects of the present disclosure is shown. The system 500 comprises the host platform 460 and may run a control and test suite or program 502 that may be created by the developer to test the target platform. The program 502 may be constructed using C# or another high-level language. The target platform here is represented as a virtualized component 462. With respect to testing of the functionality of the target platform 462 the host platform 460 (and host testing program 502) need access to, and control of, some aspects of the control program 402. In some embodiments, the system 500 provides software objects or classes that may be incorporated into the testing program 502 that give the necessary information, communication, and control aspects to fully operate and run the virtualized target platform 462.

In some embodiments, three classes are provided by the framework or system 500 for use by the host platform 460 and its associated host/testing program 502. These classes are provided by the framework, in the high level host language. A first target controller base class 508 provides for functionality that is common to the physical target platform, but independent of the specifics of the user's target application 200 itself. These functionalities may comprise starting or stopping the program 402 and obtaining diagnostic information. A second target model base class 510, generated dynamically by the framework, provides for application specific interfacing between the control program 402 of the target platform or device and the host application 502, and may inherit from the base target platform controller class 508. A third class. which may inherit interfacing elements provided by the target model base class 510, can be further extended manually in the host programming language.

Visualization of the target platform 462 may be generated by the host program 502 based upon visual components (e.g., virtual keypad 470, virtual LEDs 472, and virtual actuator 474) that are user selectable and connectable logically to various states, inputs, and outputs, from/to the target program 402.

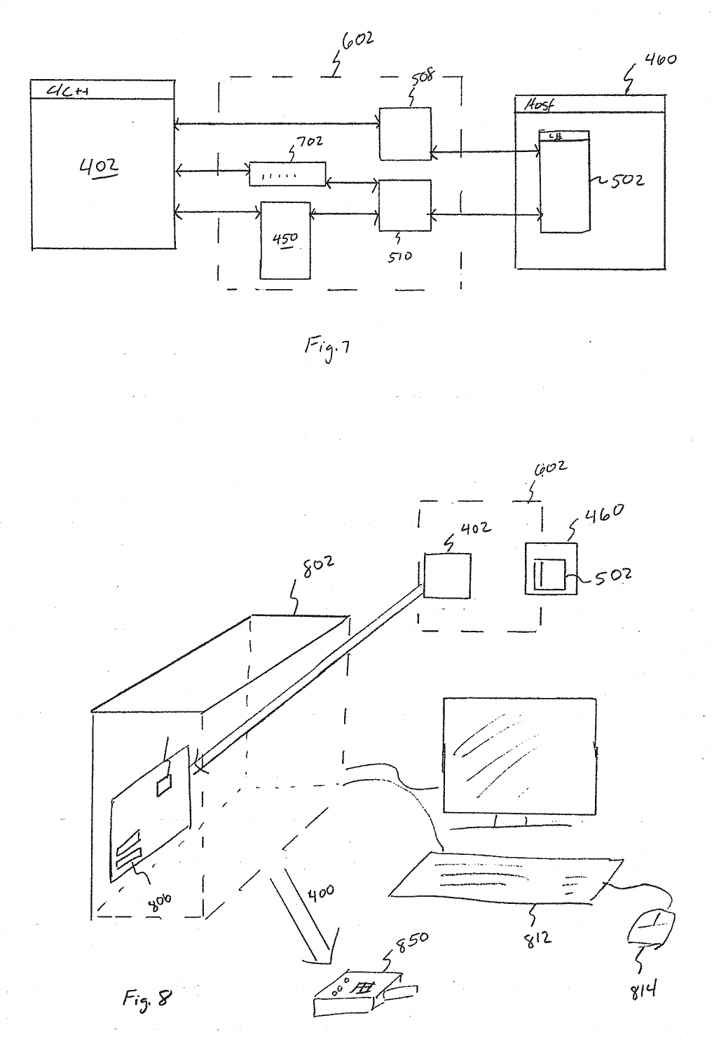

Referring now to FIG. 6, another conceptual view 600 of a system according to the present disclosure is shown. An emulation framework 602 according to the present disclosure is shown as encompassing the target controller class 508 and the target model class 510. The target model class 510 is a gateway into the target program 402 for the host application 502 to interface with. Once the controller class 508 has either started a local target 402 (or connected to a remote target, not shown) the framework 602 of the present disclosure manages the target model class 510 to keep it in sync with the target 402. In some embodiments, this is accomplished using framework concepts called “port metadata” which describe what “connection ports” of a component are, and what it means to connect one port to another. For example, when the framework is called upon to expose a memory location in 450 as a “Boolean Output” port type, from there any host component having a port that the framework understands can logically connect to a Boolean Output, such as an LED, can be connected. The framework thus provides not only the dynamic creation of the target related classes so that the target is accessible to the host, but also the interoperability framework for ports from any component including the target model to connect to other components. The details of the host language itself can thus be completely hidden from the developer.

One way that the host application 502 may interact with the target application 402 is through so-called variable binding, where any statically linked (non-stack/non-allocated) variable in the target 402 is synchronized with a corresponding variable in the target model class 510 at runtime. This is represented in the diagram 600 by both the target model class 510 and the target program 402 accessing the same memory array 450. The memory array 450 is shown as contained within the framework 602 since the framework 602 operates to synchronize read/writes of the target program 402 and the target model class 510 (which is implementing changes provided by the host program 502). However, it should be understood that, physically, the memory array 450 may be a component of the general purpose PC or computer upon with the host program 502, and possibly the target program 402, are executing.

Once a target application or program 402 is compiled and built (using any tool), the framework 602 analyzes the target build 402 and extract all information about it, including functions and statically linked variables. The user then uses the framework 602 (possibly as a plugin to the host platform 460) to configure the target model class 510 with application-specific variable bindings based on the user's needs. The variables are then exposed as “ports” of the target component 402, with port metadata indicating the variable binding type and direction for purposes of interoperability with other component ports. Not every internal value or parameter of the target program 402 may be necessary or desirable within the host program 502 for testing, debugging, etc. Every time the target 402 is built, the framework 602 may again analyze and extract information about the target 402 in the background, including all functions and statically linked variables. The user can then once again configure the target model 510 for the target 402 and use the same in the host program 502.

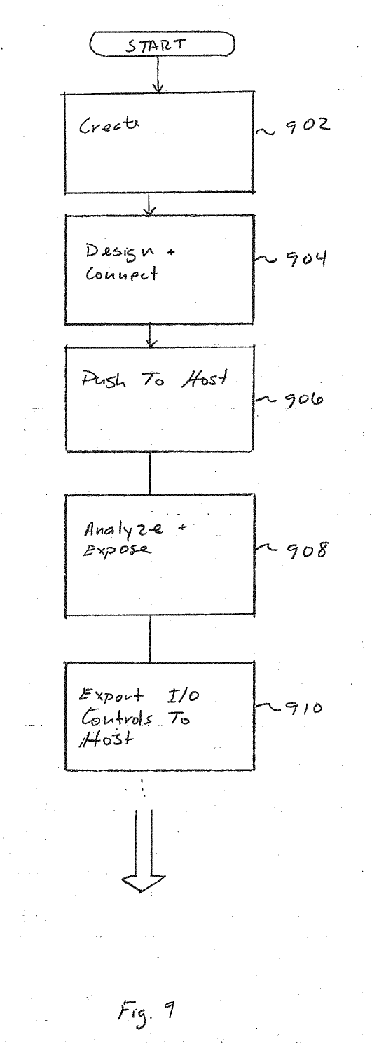

Variable binding allows statically linked variables (non-stack and non-allocated variables) or buffers of fixed length in memory to be exposed to the host program 502. A separate port interface may be needed in the cases where data flows continuously, such as A/D converters and serial data streams. Referring now to FIG. 7, a software structure chart 700 for a system for development and emulation of an embedded system according to aspects of the present disclosure configured to incorporate access to a data stream is shown. The system as modelled by the chart 700 takes account of the presence of a data stream 702.

The data stream 702 (or any data stream) may be considered as a logical flow of continuous serial data. Embedded controllers are frequently used in various forms to deal with both receiving and sending serial data streams. Various embodiments of the present disclosure, as shown by framework 602, enable complete testing and debugging of the target platform program 402 by providing shared access between a data stream 702 and the host program 502. It should be understood that in various contexts, the data stream 702 may be intended for delivery to the target program 402, and in such case may be provided by the host program 502. In other contexts, the target program 402 provides the data as a stream, and this stream may be examined or further processed for testing purposes by the host program 502. In either event, the systems of the present disclosure enable this access to the host platform 460 and host program 502 via the target model class 510.

For the host program 502, sending data to the data stream 702 (for receipt or use by the target program 402) may be a function call provided by the target model class 510 provided by the framework 602. To receive data out of the stream 702 (when data is provided from the target program 402) a different function call is implemented by the target model class 510 to accept and process the data. Access to the data stream 702 by the host program 502 via the target model class 510 may also be implemented in the host program by a subscribed event handler that would allow the host program 502 to accept and deal with data from the stream 702 any time it is generated.

Referring now to FIG. 8, a perspective view of a system 800 for development and emulation of an embedded system according to aspects of the present disclosure is shown. The system 800 is built upon an underlying platform of a general purpose computer 802, which may be a Windows, Apple, or Linux based machine, or rely on completely different architecture and operating system. The general purpose computer may comprise a logic board 804 supporting one or more random access memory chips 806 as well as non-volatile storage. A general purpose programmable CPU may be mounted to the logic board 804 with the necessary appurtenant chip sets, etc., to operate the computer 802.

The computer 802 may provide various peripherals such as a display screen 810, a keyboard 812, a mouse 814, and possibly others. An interface for the host platform 460 and/or host program 502 may be implemented for the user via the display screen 810 peripherals associated with the computer 802. It should be understood that the physical form factor of the computer 802 may vary. The computer 802 could be a laptop computer or advanced tablet style device.

The host platform 460, host program 502, target program 402, framework 602, and other components of the systems of the present disclosure may all execute or run on the same processor or processors 806 of the computer 802. The various programs, classes, and memory access routines may operate on different threads executing on the processor 806 or could be cooperatively scheduled by an advanced operating system to execute on virtual threads on the processor 806. All of the methodologies and structures described herein operate to provide a virtualized testing and development environment on or within the computer 802. As described above, once the target platform program 402 has been sufficiently refined and tested, and other necessary design details implemented using the computer 802 or otherwise, a completed control program for the target platform may be exported to one or more physical versions 850 of the target platforms. As described above, the compiled code of the target program 400, when prepared for export to a physical version 850 includes physical device drivers with interfaces and operations matching those of any virtual drivers that were used in testing.

It should be appreciated that any alterations, changes, or revisions to the physical version 850 of the target platform can be rapidly implemented and testing with the system 800, without need to build multiple incrementally changed prototypes. Changes and updates to the target platform 850 can be tested in a virtual environment as described above while allowing the developer full access to an advanced language testing suite within the host platform 460, executing on the computer 802.

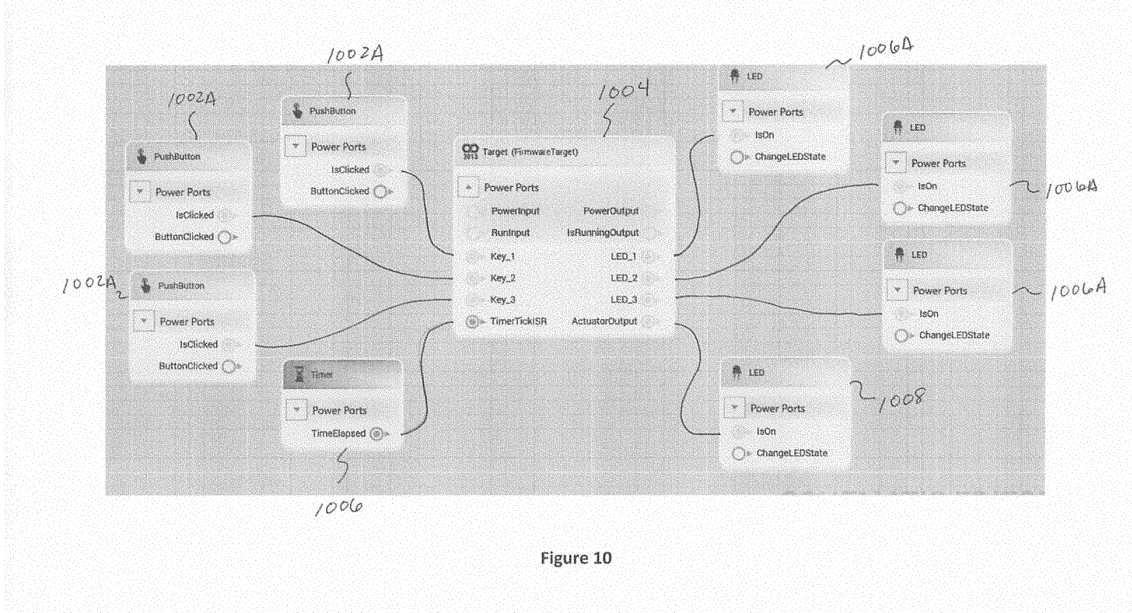

Referring now to FIG. 9 a flow chart 900 illustrating a design flow according to aspects of the present disclosure is shown. The flow chart illustrates a somewhat open-ended design process, owing in part to the flexibility of the systems of the present disclosure. At step 902 a host project is created (see also FIG. 10). At step 904 a user may drag, drop, name and/or arrange components, and connect virtual control and indication mechanisms to components associated with a desired target firmware application. Programming knowledge (i.e., coding) may not be required at this phase as the interface is graphical. When the user is satisfied with the interface and connections that have been created at this step, the project may be pushed to the host development platform at step 906. It will be appreciated that this results, for example, in completion of the underlying operation of the virtual components as shown in FIG. 4B. With this base design emitted, which will compile and run, the can add additional functionality in the host application. The schematic design (FIG. 10), which provides the base for the design, doesn't have knowledge or responsibility of this extra design, but the off-the-shelf drag-and-drop components may just be a starting point for what the user wants to do in the host language and platform. From there, the user can further implement their own functionality directly in the host language. However, the project, as provided to the host at step 906 will compile and run in the host platform (e.g., C#).

The target platform control program (e.g., 200) is analyzed at step 908 to reveal variables, functions, I/O streams and other structures as described above. These may also be exported by the framework at step 910 and made available to the host platform 460 for interoperability with the interface previously created.

It should be understood that many examples provided herein speak to transfer of information available locally on the host platform 460 into and from the target control program 200. However, systems of the present disclosure also allow for data from “real-world” sources to be provided to the tested program 200. A real-world source would be considered as data from any source remote from the host platform 460 and the general purpose computer 802 on which it executes. Basically, any data or information source available, or made available, to the host platform 460 can be used in the testing and operation of the target platform 200. This would include, without limitation, Bluetooth, GPIO, relays, GPS, and biometric data.

Referring now to FIG. 10 a graphical representation of connections between virtual input/output ports of a control program and target firmware is shown. The view of FIG. 10 may be similar to a view seen by a user when designing a logical schematic for export to the host program 502 or host platform 460. Keys 1002A may be defined and input sources and connected to inputs of the target 200 represented in FIG. 10 graphically at 1004. A timer 1006 may be defined and connected, as well as a number of LED indicators 1006A. The indicators 1006A correspond, for example, to the LEDs 13, 14, 15 of the electronic lock 10 as described above. However, a fourth LED 1008A can be seen to be connected to the actuator output of the electronic lock 10.

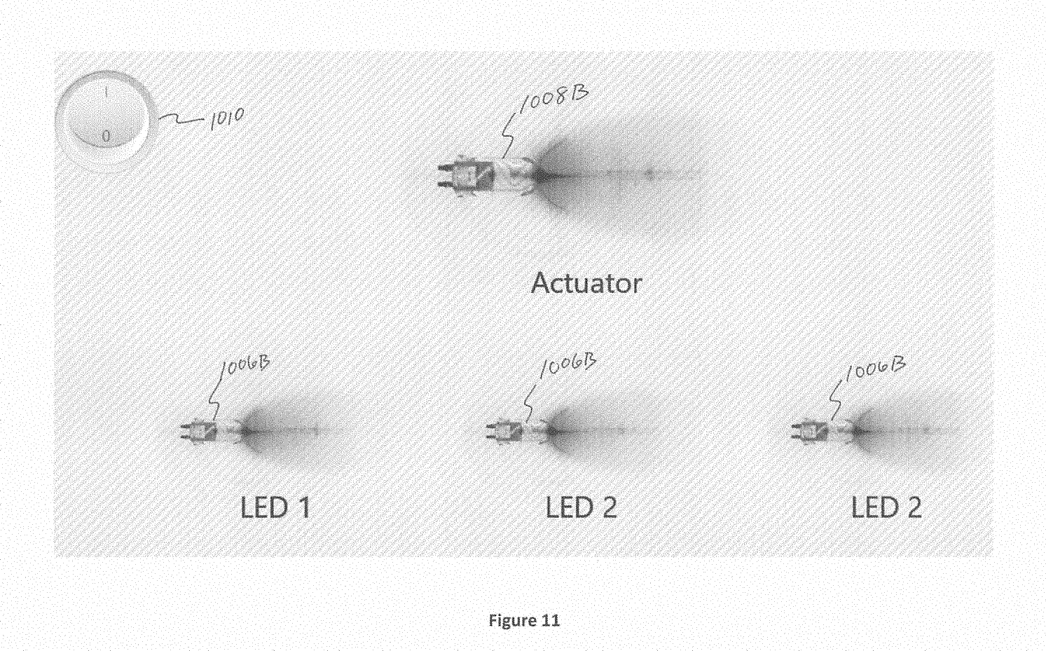

Referring now to FIG. 11 a graphical representation of the simulated hardware device 10 can be seen. Here, it can be appreciated that, for testing purposes, the actuator output is shown by illumination of a virtual LED 1008B, which corresponds to the schematic connection made to the LED 1008A above. Similarly, LEDs 1006B correspond to the schematic LEDs 1006A above. Keys 1002B correspond to the schematic keys 1002A above. Systems of the present disclosure make the components of FIG. 11 operable to a user in the same manner as they would operate on a physical device (e.g., lock 10). Observation of the LED 1008B shows the user whether the actuator has closed the lock, such that the control program 200 is fully testable. Various external type controls, such as master power switch 1010 can be used to start and stop the running of control program 200 (technically 402 since it will have been compiled with virtual drivers at this point).

It should be appreciated that more or fewer controls may be provided by the process of FIG. 9 as further illustrated in FIGS. 10-11. More or fewer controls may be needed for testing and not all internally available variables, function calls, etc. of the control program 200/402 may be needed for proper testing. However, it should be appreciated that additional controls and input/output can be readily configured according to systems and methods of the present disclosure. Controls and interfaces can be devised using the systems of the present disclosure up to and including a full HD display, for example. In one implementation of this, the data for each screen can be written by the target program 402 into a single byte array, formatted appropriately. A single single byte array binding may appear as a single port on the target model. On the host side, a port can receive the byte array and process it appropriately. The user would simply need to virtually wire these two ports together.

It should be understood that a system according to the present disclosure might be implemented a number of way by one of ordinary skill in the art, such as a Windows programmer. Any target application (200/402) must be allowed to run as a normal program, but must also be able to be debugged. A developer may need to set breakpoints at any point of the execution. The frameworks of the present disclosure attaches can attach itself to the debugger process, allowing the debugger process to be able to register breakpoints with the target process. The framework can create another thread, which runs inside the target process but on a separate logical CPU. This thread then connects to the currently executing host, using interprocess communication resources such as mutexes and pipes. Interprocess communications allow data to be shared between processes, for example when data is copied to the clipboard from one application and then pasted to another application. The thread that is created may be called the “target synchronization thread”.

The target synchronization thread has host component counterparts, the target controller base class and the target model class, which it then connects to and receives instructions regarding which data streams, variable bindings, interrupts, and events need to be marshalled between the processes. Once the target synchronization thread is properly configured and coordinated to operate with its host component counterparts, and the debugger is attached, it returns control back to the normal target application, which may then run completely independently.

During runtime, the synchronization thread executes in parallel to coordinate with the host component counterparts, to keep variable bindings synchronized, to handle interrupts and events, and to process data stream transfers. When the normal target user code 200 executes and writes to a memory location that is exposed to the host component counterpart's port, the synchronization thread is responsible for automatically identifying the data change, and providing notification to the host component.

If latency and synchronization between variable bindings are of particular concern, the user code may also specifically call a function to force synchronization before continuing, however one intent of the framework of the present disclosure is to provide completely transparent marshalling of data values and change notifications for seamless interoperability between the “normal” target code execution and its host component counterpart. In each of their respective spheres, they appear to be completely “normal” implementations, relying on the framework extensively to manage the encapsulation and interoperability.

Thus, separate processes work in tandem to provide a coordinated, optimum development experience. The host component may run as a normal application, for example a C# desktop application. The C/C++ project may run as a normal process (but would have no window of its own in Windows environment, for example). A debugger process handles debugging related runtime requirements, and attaches to both the host process and the target process. When a virtual target is virtually powered off, the host detaches the target from the debugger and kills the target process.

Systems and methods of the present disclosure are architecturally designed to accommodate containers for many different process types, not just virtualized C/C++ processes. For example, Unreal Engine containers can be pulled into the interoperability framework of the present disclosure for high-end 3D visualization of virtualized systems.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A computer based electronic device emulation and development system comprising:
a processor that executes instructions;
a random access electronic memory that stores data and instructions for execution by the processor; and
processor instructions for:
examining a target platform program and determining a first memory location utilized by the target platform program; and
providing a first software object to a host program containing a function that allows access to the first memory location.

2. The computer based electronic device emulation and development system of claim 1, wherein the first software object provides a function that allows the first memory location to be read by a host program while the target platform program is executing.

3. The computer based electronic device emulation and development system of claim 1, wherein the first software object provides a function that allows the first memory location to be written to by the host program while the target platform program is executing.

4. The computer based electronic device emulation and development system of claim 1, wherein the first software object contains a variable that is bound to the first memory location.

5. The computer based electronic device emulation and development system of claim 1, further comprising processor instructions for providing a second software object to the host, the second software object providing for the host a function to start execution of the target platform program, and a function to stop execution of the target platform program.

6. The computer based electronic device emulation and development system of claim 1, further comprising processor instructions for:
examining the target platform program and determining a data stream utilized by the target platform program; and
providing a function that allows access to the data stream with the first software object provided to the host program.

7. The computer based electronic device emulation and development system of claim 16, wherein the access to the data stream is read access.

8. The computer based electronic device emulation and development system of claim 16, wherein the access to the data stream is write access.

9. The computer based electronic device emulation and development system of claim 1, further comprising a display and processor instructions for indicating on the display contents of the first memory location retrieved by the host program using the first software object.

10. A computer based electronic device emulation and development system comprising:
a processor that executes instructions;
a random access electronic memory that stores data and instructions for execution by the processor;
an input device accepting input from a user;
an output device for displaying information to the user; and
processor instructions for:
accepting from a user a designation of a target control program for an associated embedded system;
examining the target program to determine a designation for a memory location accessed by the target control program during execution that corresponds to an input or output of the associated embedded system; and
providing to a host program a software object allowing access to the memory location.

11. The computer based electronic device emulation and development system of claim 10, further comprising instructions for providing a software object allowing the host program to begin and end execution of the target control program.

12. The computer based electronic device emulation and development system of claim 10, further comprising processor instructions for displaying in the host program a visual indication of the input or output of the embedded system based upon contents of the memory location accessed by the host program.

13. The computer based electronic device emulation and development system of claim 10, further comprising instructions for accepting input into the host program and passing the input to the memory location using the provided software object.

14. The computer based electronic device emulation and development system of claim 13, wherein the input is user provided.

15. A method of computer based electronic device emulation and development comprising:
receiving a target platform control program;
examining the target platform to determine a designated memory location corresponding to an input or output of the control program;
compiling the target platform control program with a hardware abstraction layer directing the input or output to a designated memory location;
binding the designated memory location to a software object of a host program to allow the host program to access the designated memory location; and
executing the host program and the target platform control program on the same computer and synchronizing memory reads and writes of the designated memory location between the target platform control program and the host program.

16. The method of claim 15, further comprising displaying on a computer display a visual indication of the designated memory location.

17. The method of claim 15, further comprising accepting user input into the host program for passing to target platform control program via writing to the designated memory location.

18. The method of claim 15, further comprising recompiling the target platform control program with a hardware abstraction layer corresponding to an associated physical platform.

19. The method of claim 15, further comprising providing a second software object to the host program that allows the host program to control execution of the target platform control program.

20. The method of claim 15, further comprising selecting one or more parameters corresponding to the designated memory location and displaying the selected one or more parameters to a user via the host program.
